(19) United States
(12) Patent Application Publication
(10) Pub. No.: US 2009/0161590 A1
(43) Pub. Date: Jun. 25, 2009

(54) MULTICAST DATA STREAM SELECTION IN A COMMUNICATION SYSTEM

(75) Inventors: Adam C. Lewis, Buffalo Grove, IL (US); Tyrone D. Bekiares, Chicago, IL (US); Matthew C. Keller, Algonquin, IL (US); George Popovich, Palatine, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/959,893

(22) Filed: Dec. 19, 2007

(51) Int. Cl. H04H 20/71

(52) U.S. Cl. 370/312

(57) ABSTRACT

An apparatus and method for multicast data stream selection in a communication system includes a first step 300 of providing an intermediate server between a service entity and mobile clients. A next step 302 includes receiving a join request from a mobile client. A next step 304 includes deriving subgroups with each subgroup having at least one associated multicast data stream. A next step 310 includes deriving subgroup outer tunnels. A next step 316 includes encoding different data streams for the associated subgroups. A next step 320 includes mapping each data stream to the respective outer tunnels for each subgroup. A next step 322 includes sourcing the mapped streams to each subgroup. A next step 324 includes converting the mapped streams to a form that can be recognized by the mobile clients.

### FIELD OF THE INVENTION

The present invention relates generally to wireless communication networks, and in particular, an apparatus and method for multicast data stream selection in a communication network.

### BACKGROUND OF THE INVENTION

Multimedia and group communications are becoming more important aspects of telecommunication networks and the demand for such services will continue to increase. For instance, there are presently many different systems and networks that allow group communication. Public safety organizations are particularly interested in group communications and dedicated resources are being provided for these organizations. Businesses and even personal users also have a desire to use multimedia and group communication.

A group communication has the efficiency of delivering one informational stream to many users instead of providing individual communications for each user. For example, a broadcast can be used to communicate one data stream to multiple users. However, each user terminal may not have the same communication capabilities, resulting in some users having a different communication experience from other users in the group. In this case, multiple multicast groups can be used to deliver additional communication streams with different capabilities suited for different users. Yet even in this multicast scenario with multiple multicast groups, the information stream is delivered to the group using less bandwidth than would be required if individual communication streams were sent to each user.

Accordingly, a suite of protocols has been developed for use in group communications. These protocols are used to control broadcast and multicast communications sessions including data streams such as audio (voice), video, text messaging, and internet protocols, for example between, or to, mobile clients (also referred to herein as subscribers or users) in a communications network. Each subscriber is typically associated with a communications device (also referred to herein as a mobile client or subscriber unit) that is connected to the communications network. A mobile client attempting, or paged, to join the group call is required to go through session and resource negotiations with a server supporting that session before being able to join the session. However complications arise due to mobility and operation in different wireless communication networks.

While the source of the multimedia information stream may or may not be stationary, it is expected that users participating in streaming multimedia will be operating in a highly mobile, wireless environment. In addition, one user might be operating in a broadband network while another user might be operating in a narrowband network. Further, two users operating in the same network might experience entirely different qualities of service, as one user might be in a scarcely populated cell and close to an access point while another user might be in a heavily populated cell and far from an access point. Also, subscribers will receive the stream on potentially different subscriber devices—some anemic with little battery power, others powered by a vehicle engine, and some with different display capabilities (video and voice, voice only, large screen vs. small screen, etc.). Each user, regardless of their local conditions is interested in receiving the best quality multimedia experience as their subscriber device and current network attachment allows, while also accommodating network condition changes due to mobility or operational changes.

One solution to the problem is to provide dynamic feedback from a user terminal to the information sender. However, this solution does not work well for group calls where there may be many different subscribers experiencing many different network conditions. Another problem is the sender must receive and process the feedback information, make decisions on what to send to whom, and generate multiple copies of the media, which takes considerable overhead. This can be difficult where the sender's device is a mobile terminal with limited processing resources. Additionally, if the sender is mobile, the feedback information must traverse an outbound wireless link to get to the sender and multiple copies of the media must be sent inbound on the wireless link, both consuming limited resources.

Another solution to the problem has been to stream multiple versions of the same multimedia source at different rates for different multicast groups with the subscribers selecting between groups/rates. This solution also requires significant application interaction with the network, which may not result in an optimum use of resources. In particular, this solution requires the application or user to be cognizant of changing conditions, and to know of the existence of multiple multicast groups, and to know which group to switch to. This places a high burden of knowledge on the higher level applications and/or user.

Therefore, a need exists for an apparatus and method for multicast data stream selection in a communication network. It would also be of further benefit to accommodate a mobile device that traverses different networks and to transparently subscribe the user to the optimum data stream.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 illustrates a simplified block diagram of a call control architecture, in accordance with the present invention;

FIG. 2 illustrates a simplified flow diagram, in accordance with the present invention; and

FIG. 3 illustrates a method, in accordance with the present invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF THE PREFERRED EMBODIMENT

The present invention provides an apparatus and method for multicast data stream selection in a communication network. The present invention can also accommodate a mobile device that traverses different networks and transparently subscribes the user to the optimum data stream.

In particular, the present invention enables a mobile client traversing heterogeneous communication networks to receive multimedia packet data streams optimized for their subscriber device and its current Access Network (AN) attachment (e.g. narrowband wireless, broadband wireless, wired LAN, etc.). Further, the present invention enables the receiving application on the subscriber device to maintain it's normal operation and join only a single multicast group (as advertised via a control plane signaling, as exemplified by, but not limited to, SAP (Session Announcement Protocol) or Session Initiation Protocol (SIP) for example) while a dedicated intermediate application transparently subscribes the receiving application to the optimal data stream which can be supported by the AN. Preferably, all this is accomplished in a secure manner supporting confidentiality, authentication, and integrity of the multimedia data stream, using VPN services as are known in the art.

Specifically, the present invention introduces a middleware layer in a mobile server and/or a mobile client, as a switching mechanism to pick the right tunneled stream, and is transparent to the applications. This alleviates having to place a large amount of intelligence in the applications, and keeps the intelligence where it is known best (the middleware client that has network-specific knowledge such as available throughput, jitter characteristics, etc.). Advantageously, no change is required to client code which joins a single multicast group for a given stream. The mobile server is unique in that it is able to derive subsets of Access Network (AN) optimized multicast groups for each default group and encodes and sources multicast streams optimized for each of these subgroups. Using network address translation (NAT) an inner multicast subgroup (i.e. the innermost tunneled end-to-end multicast IP packet, which is related to VPN, Mobile VPN, or Mobile IP, as is known in the art) is translated back to the default group, at either the mobile server or the mobile client, making the switching transparent. Importantly, the present invention is compatible with the use of secure multicast techniques.

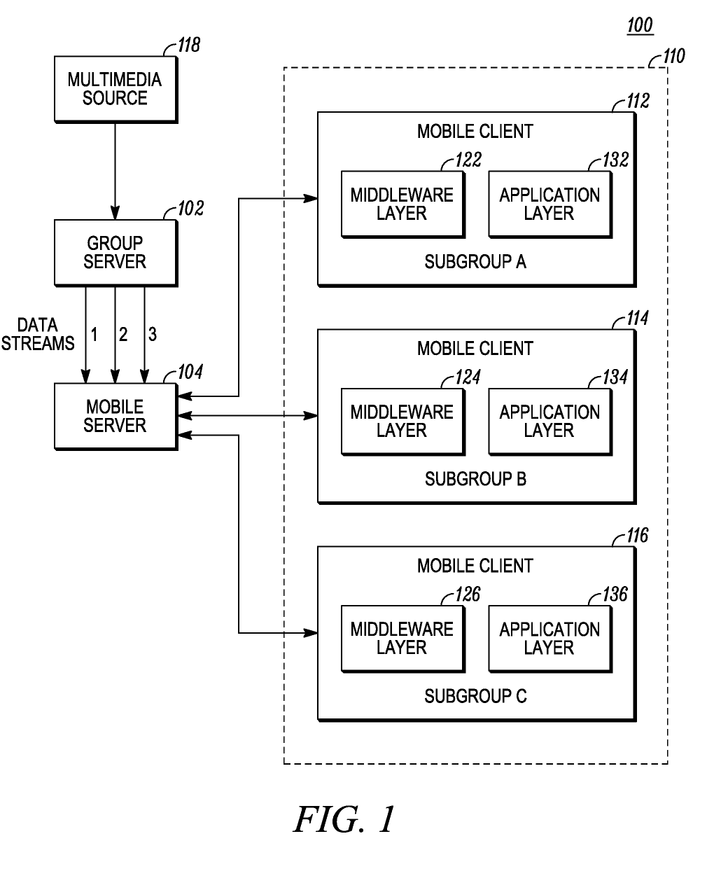

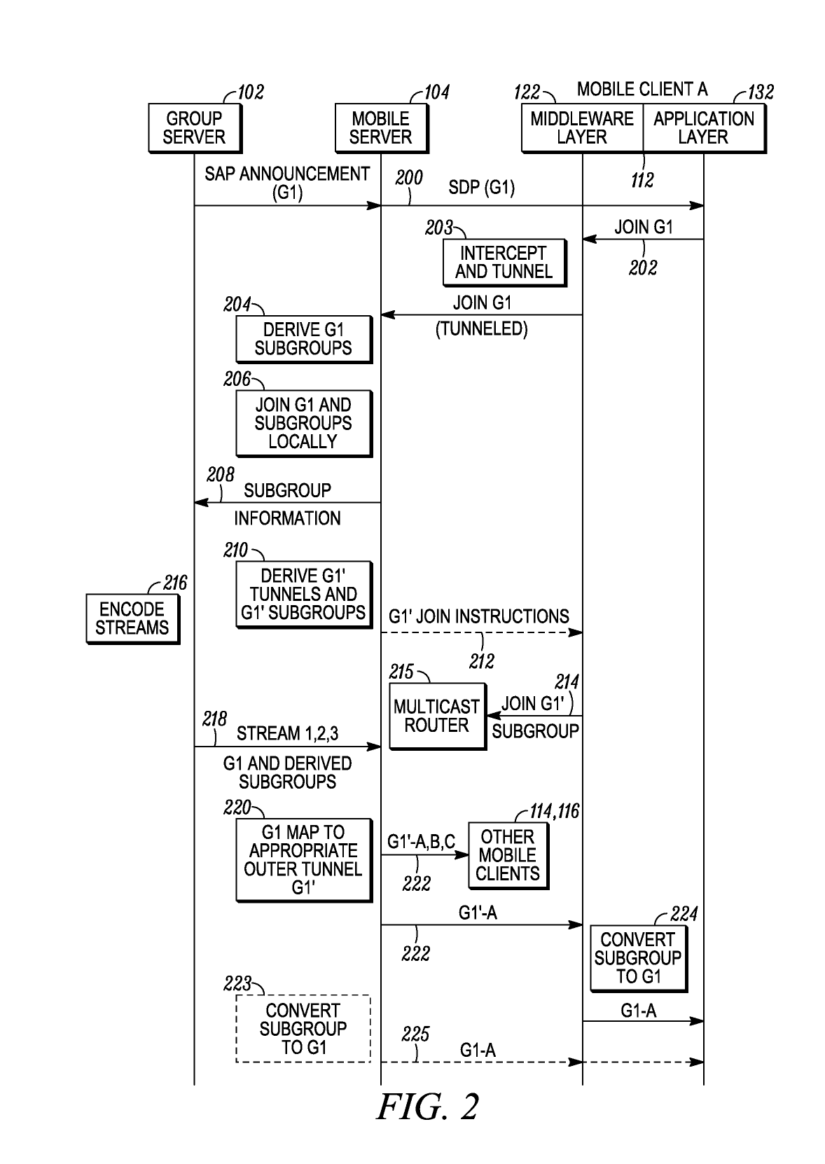

Referring to FIGS. 1 and 2, the present invention provides for a multimedia group communication implemented in a server-centric call control architecture 100. This architecture 100 may be included in a push-to-talk (PTT), push-to-video or push-to-x communications system, for example. The architecture 100 includes a service-specific service entity (i.e. a group server which can include a Push-to-Talk (PTT) server function and multimedia server function.) 102, which may be for instance a PTT server, that can be communicatively coupled through one or more radio access networks to a plurality of mobile or fixed clients that are affiliated in separate multicast subgroups having common communication capabilities, shown here as three subgroups; A 112 (shown as an example in FIG. 2), B 114, and C 116, and optionally a multimedia source 118. The group server 102 may also contain a data stream router, as is known in the art. The mobile server 104 is the network termination point and interfaces between the group server and the subgroups 112-116 of the mobile clients.

A call control flow is established on communication paths for enabling communications in a communications network 100 between a service entity 102 (e.g. group server) and a plurality of mobile clients 112, 114, 116 in a communications system, in accordance with the present invention. In particular, the call flow of FIG. 2 demonstrates how a mobile client joins a group call. Each mobile client typically comprises a logical entity, e.g., a user, and a physical counterpart, e.g., a terminal, as part of a group entity (110 of FIG. 1) that is named and addressable at a novel middleware layer, incorporated as a Virtual Private Network (VPN), Mobile VPN, or Mobile Internet Protocol (IP), as are known in the art, 122-126 and the application layer 132-136. The preferred transactional broadcast protocol is Session Announcement Protocol (SAP). However, it should be recognized that obvious variations of the present invention could be utilized in protocols such as Session Initiation Protocol (SIP) and Session Description Protocol (SDP), for example.

The group communication is a session supported by the group server 102, which is known to the mobile clients in subgroups 112, 114, and 116 of a group 110. Prior to establishing a group communication between or from a group server 102 and a mobile client, the group server may know the group affiliation of the mobile clients. For example, the mobile client or mobile server 104 can provide this information to the group server. In another example, the affiliations can be predetermined by the group server 102 or the mobile server 104. Alternatively, a mobile client could be provisioned with a group affiliation by a service provider, which is communicated directly to the group server 102 and/or mobile server 104 by the service provider (not shown). In another alternative, the group affiliation could be selected by the mobile client (e.g. communication group, multicast group, or subgroup), and the group server 102 would learn about that affiliation when the mobile client generates or responds to a group request. In yet another alternative, the subgroup affiliations of the mobile clients can be determined through statistical mapping (e.g. use statistical means to determine what units should be part of which subgroups, for example based on historical information of location, available throughput, etc.) by the group server 102 or mobile server 104.

To setup a session, the group server 102 establishes the group call and its required applications, and sets up a multicast invitation by sending 200 a Session Initiation Protocol (SIP) INVITE message (not shown) or Session Announcement Protocol (SAP) announcement containing Session Description Protocol (SDP) to the application layer 132-136 of mobile clients of the group 110. Call control signaling identifies the mobile clients in the affiliated group. For example, the affiliated mobile clients of the group 110 are paged with the group identification (group ID) of the group call in the SIP INVITE or SAP announcement. Alternatively, instead of a single group ID, the group invite might contain a list of all mobile clients desired for this call. The group SIP INVITE or SAP announcement contains information that a call is being setup for the invited mobile clients, wherein the mobile clients can go through a negotiation process before participating in the group call.

A mobile client receiving and processing the group SIP INVITE or SAP announcement can subsequently reply with a join message for the multicast group G1. Specifically, each mobile client sends a join request 202 for G1. The multicast group join message is intercepted 203 by the mobile client's middleware application and reverse-tunneled to the mobile server 104, preferably via a secure Virtual Private Network (VPN). The mobile server then derives 204 AN-specific multicast subgroups (e.g. G1-Subgroup B and G1-Subgroup C) from the default G1 group of the call. In this example, it is assumed that G1-Subgroup A is the default G1 group and need not go through any further derivation. The decision on whether to perform this special behavior for the multicast group could be based on multicast address range, a configuration file, (or possibly some other explicitly signaled mechanism).

The mobile server 104 locally joins 206 all three multicast subgroups (the default G1-Subgroup A and derived G1-Subgroup B and G1-Subgroup C) natively, thereby by-passing the VPN tunnel. Optionally, the mobile server 104 may then relate 208 this subgroup information on behalf of the mobile clients to the group server 102, if the group server does not know of the subgroup information already.

In addition, the mobile server middleware derives 210 multicast-prime subgroup tunnels for subscriber subgroups A/B/C, i.e. G1′/Subgroup A, G1′/Subgroup B, and G1′/Subgroup C, respectively. The multicast prime subgroup tunnels are outer tunnel subgroups of G1 that correspond to the different multicast subgroups.

In a group call, the different application streams or flows for each subgroup inside a group session can be accessed by the mobile clients in the group. The group server 102 or mobile server 104 establishes what specific application streams (flows) are available or required for each subgroup of the group call. These applications or flows can include audio (voice), video, text messaging, and internet protocols, for example, each of which require different resources or capabilities in a mobile client that participates in the group call. It should be recognized that different mobile clients of the group could have a wide range of resources or capabilities, and some may not be able to participate in the full group session due to such limitations.

There is a common capability or resource limitation amongst the defined subgroups of mobile clients which the group server can use to set up and encode a 216 common multicast group to deliver communications for just that subgroup. For example, the group server can provide video content at a lower data rate to be properly received in those mobile clients of a subgroup having a common QoS level capability. In particular, the degraded stream can be given an identifier, either a separate actual IP address or port, or some other stream header identifier if sent to the same IP address and port, that the subgroup can decode as stream content that is intended for them only. In this example, three different data streams 1, 2, 3 are setup up and encoded.

The mobile server can optionally instruct 212 the mobile clients how to natively multicast join the appropriate G1′ outer tunnel or the mobile clients can determine this on their own. Each mobile client then joins 214 either the G1′/Subgroup A, G1′/Subgroup B, or G1′/Subgroup C to an Internet multicast router 215 for example, per the instructions and locally depending on AN characteristics.

The group server 102 encodes 216 the data stream from the multimedia source 118 multiple times. Specifically, the encoding details a transcoding that is optimized for each subgroup. For example, a default encoding (G1-Subgroup A Stream 1) can be provided for mobile clients (Subgroup A) without special capabilities. A second encoding (G1-Subgroup B Stream 2) can be optimized for broadband RANs (Subgroup B), and a third encoding (G1-Subgroup C Stream 3) can be optimized for narrowband RANs (Subgroup C). The G1 streams are delivered 218 to the mobile server 104 acting on behalf of the mobile clients.

The three streams are received (intercepted) by the mobile server (due to its previous joining of the three subgroups) and the mobile server decides which stream gets coupled to which multicast address. In particular, the mobile server maps 220 each G1 stream to its associated G1′ outer tunnel to place the inner tunnel's G1 inside of the outer tunnels G1′, i.e. G1-Subgroup A is tunneled inside of G1′-Subgroup A, G1-Subgroup B is tunneled inside of G1′-Subgroup B, and G1-Subgroup C is tunneled inside of G1′-Subgroup C. Tunneling G1 inside of G1′ allows native multicast behavior/optimal routing to be enabled, while at the same time enabling the confidentiality and integrity of the content.

The mobile server can then source 222 the G1′/G1 streams for each of Subgroups A, B, C via the G1 tunnel to each multicast subgroup of mobile clients. As shown for Subgroup A and associate mobile client 112, middleware in each mobile client, or a local router therefore, converts 224 (i.e. strips off) G1′ and Network Address Translates (NAT) the subgroup back to G1 (which is expected and can be recognized by the application layer of the mobile client). It is again assumed here that Group A is the default G1 stream. Alternatively, this Network Address Translation functionality 223 could be done at the mobile server prior to tunneling 225 the G1 packet downstream to the application layer of the mobile client in the appropriate subgroup.

In a further embodiment, as a mobile client roams from one access network node (AN) to another, from good to poor AN characteristics, the mobile client middleware can select an appropriate multicast subgroup and trigger a multicast join (see 202 above)—all transparent to the client application. Hence with the present invention, mobile clients for Subgroup B will receive multimedia streams optimized for Subgroup B while mobile devices for Subgroup C will receive multimedia streams optimized for Subgroup C. It should be noted that while the above description of logic ties the encoding to AN type, it is not limited to this scope. For example a more granular implementation might encode multiple streams for the same AN type, but targeted toward different conditions (e.g. RF) and characteristics (e.g. available bandwidth) within the AN (e.g. congestion in AN, distance from access point, etc.) For example two mobile devices connected to a given AN but with distinct coverage conditions (e.g. directly under the access point versus on the fringe) might join two different subgroups (e.g. G1-Subgroup A-close vs. G1-Subgroup A-far). However, the initial description (on encoding per AN type) is the most likely embodiment as it is the least complicated.

It should be recognized that the diagrams of FIGS. 1 and 2 are simplified for purposes of illustrating the present invention. However, those of ordinary skill in the art will realize that many other network entities may be part of the communication system. For example, the group server 102 can include many other entities which have not been shown for the sake of simplicity. For example, the group server can include one or more of a session controller, a group database manager, a registration manager, a gateway, an application layer router, a group entity manager, a broadcast and unicast address manager, a policy manager, a floor controller, a media manager, and a bandwidth manager, among others, all of which are known in the art. It should be appreciated that the above described entities can be integrated in the same physical or logical network element (i.e. group server), or provided as separate physical or logical network elements.

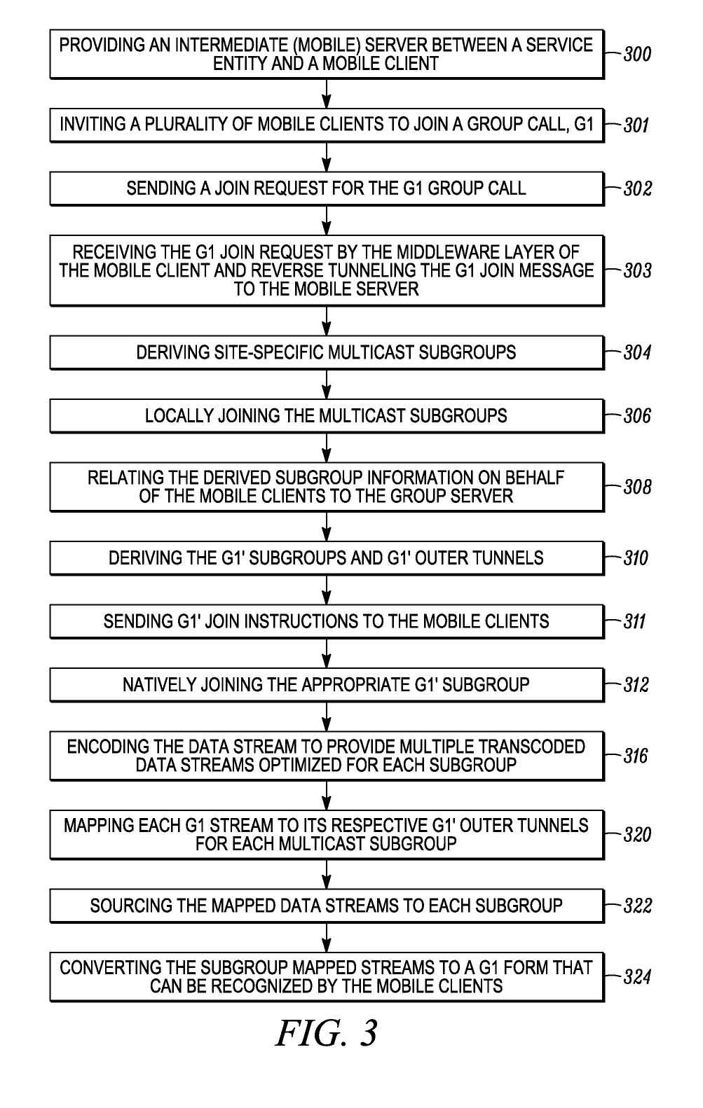

FIG. 3 illustrates a method for multicast data stream selection in a communication system. The method includes a first step 300 of providing an intermediate (mobile) server between a service entity and a plurality of mobile clients. The mobile clients include middleware in a middleware layer for implementing the present invention.

A next step 301 includes inviting a plurality of mobile clients to join a group call, G1.

A next step 302 includes sending a join request to join the group G1 call by the application layer of the mobile client.

A next step 303 includes receiving or intercepting the G1 join request by the middleware layer of the mobile client and reverse tunneling the G1 join message to the mobile server via a secure Virtual Private Network (VPN), Mobile VPN, or Mobile IP.

A next step 304 includes the mobile server deriving AN-specific multicast subgroups (e.g. G1-Subgroup B and G1-Subgroup C) from the default G1 group of the call with at least one multicast stream for each subgroup.

A next step 306 includes the mobile server locally joining the multicast subgroups.

A next step 308 optionally includes the mobile server relating the derived subgroup information on behalf of the mobile clients to the group server.

A next step 310 includes the mobile server deriving the G1′ subgroups and G1′ outer tunnels. As used herein, this step also covers the case where a subgroup is formed for a particular set of parameters even if no mobile clients join the subgroup.

A next step 311 optionally includes the mobile server sending G1′ join instructions to the mobile clients. This optional step has the mobile server instruct the mobile clients how to natively join the appropriate G1′ subgroup. However, the mobile clients may be able to determine this on their own, and can join locally depending on a number of factors, for example current AN characteristics such as coverage or connectivity.

A next step 312 includes the mobile clients natively joining the appropriate G1′ subgroup with a multicast router.

A next step 316 includes the group server encoding the source data stream to provide multiple transcoded data streams optimized for each subgroup.

A next step 320 includes the mobile server mapping each G1 stream to its respective G1′ outer tunnels for each multicast subgroup to place the inner tunnels inside of the outer tunnels.

A next step 322 includes the mobile server sourcing the mapped data streams to each subgroup using the native multicast destination address from the outer tunnel. In the example shown, the G1′-A subgroup is sourced to mobile client A, and any or all of the G1′ subgroups can be sourced to the other mobile clients.

A next step 324 includes converting the subgroup mapped streams to a G1 form that can be recognized by the mobile clients using address translation.

Alternatively, step 322 and 324 can have the mobile server converting the subgroup mapped streams to a G1 form that can be recognized by the mobile clients using address translation, and then sourcing the G1 data streams to the associated mobile clients.

Optionally, a step includes ascertaining a change in a connection characteristic (e.g. coverage quality) for a mobile client, wherein the mobile client middleware selects an appropriate multicast subgroup for the mobile client, and triggers a multicast join for the mobile client on a different subgroup, transparently to the application.

In another option, a step includes ascertaining a change in a operational characteristic (e.g. battery power level, handover event, etc.) for a mobile client, wherein the mobile client middleware selects an appropriate multicast subgroup for the mobile client, and triggers a multicast join for the mobile client on a different subgroup. For example, a low battery power level might cause the middleware to join a multicast group carrying a lower-bandwidth encoding of a view stream, in order to spend less CPU cycles processing received video frames.

In another embodiment, a step includes encoding multiple subgroups for different network conditions in the same AN.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for multicast data stream selection in a communication system, the method comprising the steps of:
providing an intermediate server between a service entity and a plurality of mobile clients;
receiving a join request from a mobile client;
deriving subgroups of the mobile clients with each subgroup having at least one associated multicast data stream;
deriving subgroup outer tunnels;
encoding the source data stream into different data streams for the associated subgroups;
mapping each data stream to the respective outer tunnels for each subgroup;
sourcing the mapped streams to each subgroup; and
converting the mapped streams to a form that can be recognized by the mobile clients.

2. The method of claim 1, further comprising the steps of:
inviting a plurality of mobile clients to join a group call;
joining the group call.

3. The method of claim 1, further comprising the step of the intermediate server locally joining the multicast subgroups.

4. The method of claim 1, further comprising the step of relating the derived subgroup information on behalf of the mobile clients to the service entity.

5. The method of claim 1, further comprising the step of natively joining the appropriate outer tunnels.

6. The method of claim 5, wherein the step of joining includes the intermediate server instructing the mobile clients to natively join the appropriate outer tunnel.

7. The method of claim 5, wherein the step of joining includes the mobile clients natively joining the appropriate outer tunnel.

8. The method of claim 1, wherein the sourcing step includes delivering the multiple streams using the native address from the outer tunnel.

9. The method of claim 1, wherein the service entity is a group server for multimedia group calls.

10. The method of claim 1, further comprising the steps of:
ascertaining a change in AN characteristic for a mobile client;
selecting an appropriate multicast subgroup for the mobile client, and
triggering a multicast join for the mobile client.

11. The method of claim 1, further comprising the steps of:
ascertaining a change in operational characteristic for a mobile client;
selecting an appropriate multicast subgroup for the mobile client, and
triggering a multicast join for the mobile client.

12. The method of claim 1, further comprising the step of encoding multiple streams for different RF conditions within the same AN.

13. A method for multicast data stream selection in a communication system, the method comprising the steps of:
providing an intermediate server between a group server and a plurality of mobile clients;
inviting a plurality of mobile clients to join a group call;
the mobile clients joining the group call via a pipe in a reverse tunnel to the intermediate server;
receiving the join request by the intermediate server;
the intermediate server deriving AN-specific multicast subgroups from the default group of the call with at least one multicast data stream for each subgroup;
the intermediate server locally joining the multicast subgroups;
the intermediate server deriving subgroup outer tunnels;
natively joining the appropriate outer tunnels;
the group server encoding the multicast data stream to provide multiple transcoded data streams optimized for each subgroup;
the intermediate server mapping each data stream to its respective outer tunnels for each multicast subgroup to place inner tunnels inside of the outer tunnels;
the intermediate server sourcing the mapped streams to each subgroup; and
converting the mapped streams to a form that can be recognized by the mobile clients.

14. The method of claim 13, further comprising the step of relating the derived subgroup information on behalf of the mobile clients to the group server.

15. The method of claim 13, wherein the step of joining includes the intermediate server instructing the mobile clients to natively join the appropriate outer tunnel.

16. The method of claim 13, wherein the step of joining is locally dependent on AN characteristics.

17. The method of claim 13, further comprising the step of delivering the multiple streams.

18. The method of claim 13, further comprising the steps of:
ascertaining a change in coverage quality for a mobile client;
selecting an appropriate multicast subgroup for the mobile client, and
triggering a multicast join for the mobile client.

19. The method of claim 13, further comprising the step of encoding multiple streams for different conditions in the same AN.

20. An apparatus for multicast data stream selection between a service entity and a plurality of mobile clients in a communication system, the apparatus comprising:
an intermediate server coupled between a service entity and a plurality of mobile clients, the intermediate server receiving a join request from a mobile client, deriving subgroups having at least one associated multicast stream, deriving subgroup outer tunnels, receiving data streams encoded into different data streams for the associated subgroups, mapping each data stream to the respective outer tunnels for each subgroup, sourcing the mapped streams to each subgroup to be converted to a form that can be recognized.
